(19) United States
(12) Patent Application Publication
(10) Pub. No.: US 2018/0127944 A1
(43) Pub. Date: May 10, 2018

(54) Insulating Device for Building Foundation Slab

(71) Applicant: TB Holdings, LLC, Fort Wayne, IN (US)

(72) Inventor: Tony Hicks, Roanoke, IN (US)

(73) Assignee: TB Holdings, LLC, Fort Wayne, IN (US)

(21) Appl. No.: 15/803,552

(22) Filed: Nov. 3, 2017

Related U.S. Application Data
(63) Continuation of application No. 14/038,407, filed on Sep. 26, 2013, now abandoned.
Application No. 14/038,407 is a continuation-in-part of application No. 13/733,188, filed on Jan. 3, 2013, now abandoned.

(51) Int. Cl. E02D 31/00; E04B 1/74; E02D 27/01; E02D 27/02; E04B 1/16; E04C 5/01; E04C 3/34; E04B 1/72; E04B 1/30; E04B 1/76

(52) U.S. Cl. CPC E02D 31/00; Y02B 30/94; E02D 27/01; E02D 27/02; E04B 1/16; E04B 1/165; E04C 5/01; E04C 3/34; E04B 1/72; E04B 1/30; E04B 2001/7679; E04B 2001/7691; Y02A 30/261; E04B 2001/742; E04B 1/74

(57) ABSTRACT

A device for insulating the slab foundation of a building, said device comprising: a generally horizontal insulating section disposed between the slab foundation and a footer of a building, said horizontally disposed insulating section comprising a generally elongated cuboid shape having at least one cutout through which a concrete column is disposed; said prefabricated device further comprising a generally vertical insulating section disposed adjacent to said horizontal insulating section and attached to said building.

### CROSS-REFERENCE TO RELATED APPLICATIONS

This application is a continuation of U.S. patent application Ser. No. 14/038,407 filed Sep. 26, 2013, entitled Insulating Device for Building Foundation Slab, by Tony Hicks, which is a continuation-in-part of U.S. patent application Ser. No. 13/733,188 filed Jan. 3, 2013, entitled Thermal Barrier For Building Foundation Slab, by Tony Hicks.

### BACKGROUND

### 1. Field of the Art

This invention is related to building construction. More particularly, this invention is an insulation device for slab foundations of residential and commercial buildings.

Most residential and smaller commercial buildings in the United States are built using standardized building practices. One reason for this consistency is a set of uniform building codes that apply across the country. Another reason is cost. The techniques used to build homes, for example, produce reliable structures quickly at relatively low cost. Homes in the United States are generally built using the following procedure: grading and site preparation, foundation construction, framing, window and door installation, roofing, siding, electrical, plumbing, HVAC, insulation, drywall, underlayment, trim, and interiors.

One of the first steps in erecting a residential or commercial building is constructing a foundation. Houses, for example, are generally built on a crawlspace, basement, or slab foundation.

The slab is the easiest foundation to build. It is a flat concrete pad poured directly on the ground. It takes very little site preparation, very little formwork for the concrete, and very little labor to create.

For a typical slab foundation, a concrete perimeter is embedded in the ground around three feet deep. The slab further comprises a four to six-inch-thick flat surface atop the embedded perimeter. A layer of gravel lies beneath the slab, and a sheet of plastic lies between the concrete and the gravel to keep moisture out. Wire mesh and/or steel reinforcing bars are implanted in the concrete for additional structural integrity. In colder climates, the concrete perimeter has to extend deep enough into the ground to remain below the frost line in winter.

Slab foundations work well on level sites in warmer climates. However, in colder climates, where the ground freezes in the winter, use of a non-insulated slab results in cold floors and higher heating costs as heat is lost from the home to the outside.

Slabs lose energy primarily due to heat conducted outward and through the perimeter of the slab. Insulating the exterior edge of the slab in most sections of the country can reduce winter heating bills by 10% to 20%. In fact, slab insulation is recommended in many localities by state energy codes.

State energy and building codes regarding slab insulation and energy savings are often guided by model codes such as the International Energy Conservation Code (“IECC”). These objectives are generally expressed in terms of R-values and U-values.

Thermal conductivity is the rate of thermal conduction through a material per unit area per unit thickness per unit temperature differential. The inverse of conductivity is resistivity (or R per unit thickness). Thermal conductance is the rate of heat flux through a unit area at the installed thickness and any given delta-T.

The R-value is a measure of thermal resistance used in the building and construction industry. Under uniform conditions, the R-value is the ratio of the temperature difference across an insulator to the heat flux (heat transfer per unit area) through it. Thus, the R-value for any particular material or apparatus is the unit thermal resistance. R-value is expressed as the thickness of the material divided by the thermal conductivity. For the thermal resistance of an entire section of material, instead of the unit resistance, divide the unit thermal resistance by the area of the material. A relatively higher R-value denotes a more effective insulator. U-value is the reciprocal of R-value.

Experimentally, thermal conduction for a particular material is measured by placing the material in contact between two conducting plates and measuring the energy flux required to maintain a certain temperature gradient. Generally, the R-value of insulation is measured at a steady temperature, usually about 70° F. with no forced convection.

In the United States, R-value is expressed as h*ft²*° F./Btu, where h=hours; ft=feet; and ° F.=Fahrenheit temperature. The conversion between SI and US units of R-value is 1 h·ft²·° F./Btu=0.176110 K·m²/W.

The IECC for 2012 details recommended R-values and U-values for slab building foundations, as shown in the following table where R-values are minimums and U-values are maximums.

TABLE 1

| | | SLAB R-VALUE & |
|---|---|---|
| | FENESTRATION | DEPTH |
| CLIMATE ZONE | U-FACTOR | (h * ft² * ° F./Btu) |
| 1 | NR | 0 |
| 2 | 0.40 | 0 |
| 3 | 0.35 | 0 |
| 4 except Marine | 0.35 | 10, 2 ft |
| 5 and Marine 4 | 0.32 | 10, 2 ft |
| 6 | 0.32 | 10, 4 ft |
| 7 and 8 | 0.32 | 10, 4 ft |

A “climate zone” number is a description of the climate in a particular geographic area, based on the number of heating days, the number of cooling days, the amount of precipitation, and other factors in a particular geographic region. The IEEC tables below show specific climate zone definitions.

INTERNATIONAL CLIMATE ZONE DEFINITIONS (Table 2)
MAJOR CLIMATE TYPE DEFINITIONS

Marine (C) Definition - Locations meeting all four criteria:

| | |
|---|---|
| 1. | Mean temperature of coldest month between −3° C. (27° F.) and |
| | 18° C. (65° F.) |
| 2. | Warmest month mean <22° C. (72° F.) |
| 3. | At least four months with mean temperatures over 10° C. (50° F.) |
| 4. | Dry season in summer. The month with the heaviest precipitation in |
| | the cold season has at least three times as much precipitation as the |
| | month with the least precipitation in the rest of the year. The code |
| | season is October through March in the Northern Hemisphere and |
| | April through September in the Southern Hemisphere. |

Dry (B) Definition - Locations meeting the following criteria: Not Marine
and Pin <0.44 × (TF − 19.5) [Pcm <2.0 × (TC + 7) in SI units] where:
Pin = Annual precipitation in inches (cm)
T = Annual mean temperature in ° F. (° C.)
Moist (A) Definition - Locations that are not Marine and not Dry.

INTERNATIONAL CLIMATE ZONE DEFINITIONS (Table 3)

| ZONE | THERMAL CRITERIA | |
|---|---|---|
| NUMBER | IP Units | SI Units |
| 1 | 9000 < CDD50° F. | 5000 < CDD10° C. |
| 2 | 6300 < CDD50° F. :: 9000 | 3500 < CDD10° C. :: 5000 |
| 3A and 3B | 4500 < | 2500 < |
| | CDD50° F. | CDD10° C. |
| | :: 6300 | :: 3500 |
| | AND | AND |
| | HDD65° F. | HDD18° C. |
| | :: 5400 | :: 3000 |
| 4A and 4B | CDD50° F. | CDD10° C. |
| | :: 4500 | :: 2500 |
| | AND | AND |
| | HDD65° F. | HDD18° C. |
| | :: 5400 | :: 3000 |
| 3C | HDD65° F. :: 3600 | HDD18° C. :: 2000 |
| 4C | 3600 < HDD65° F. :: 5400 | 2000 < HDD18° C. :: 3000 |
| 5 | 5400 < HDD65° F. :: 7200 | 3000 < HDD18° C. :: 4000 |
| 6 | 7200 < HDD65° F. :: 9000 | 4000 < HDD18° C. :: 5000 |
| 7 | 9000 < HDD65° F. :: 12600 | 5000 < HDD18° C. :: 7000 |
| 8 | 12600 < HDD65° F. | 7000 < HDD18° C. |

The Building America marine climate corresponds to those portions of IECC climate zones 3 and 4 located in the “C” moisture category.

Thus, a need exists for a thermal barrier that can be attached to a slab foundation for residential or commercial buildings to prevent heat loss from the building through the slab. Slabs lose energy primarily due to heat conducted outward and through the perimeter of the slab. Insulating the exterior edge of the slab in most sections of the country can reduce winter heating bills by 10% to 20%. In fact, slab insulation is recommended in many localities by the Model Energy Code or state energy codes.

### 2. Description of the Prior Art

U.S. Pat. No. 5,295,337 discloses an isolation element for the isolation of vibrations and/or heat, which propagate/s in a medium such as soil, as well as the application of isolation element in an isolation arrangement. The isolation element is characterized by a rectangular plate-shaped block with one or several on one or both of the two side surfaces attached cushion-shaped bodies. The isolation arrangement is characterized by a trench in the ground, in the bottom of the trench preferably vertically anchored guide rods placed in a row, in the trench poured stabilizing slurry as well as on the guide rods threaded and from the bottom of the trench to the orifice and preferably along the whole length of the trench on top of each other and/or next to each other stacked isolation elements placed on their edges.

U.S. Pat. No. 5,352,064 discloses a collapsible spacer for disposition between a form for a concrete foundation member and the underlying soil includes voids to allow the spacer to deform permanently and occupy a reduced volume when upheaving of the soil occurs. The spacer is fabricated from a material, such as expanded polystyrene foam, whose structural strength is not significantly altered by exposure to moisture.

U.S. Pat. No. 5,433,049 discloses a prefabricated building system for the laying of the foundations for a heated building with a beam structure above an enclosed, unventilated creep space. The foundations are constructed from base plates made of concrete, foundation beams made of concrete with internal cellular plastic, and ventilation grids for ventilation. The foundation beams consist of an externally reinforced high concrete slab with thick, cast-on-cellular plastic insulation on the inside. The creep space can be inspected more easily thanks to the considerable height of the foundation beams. The thick cellular plastic insulation on the foundation beams enables surplus heat to be utilized, so that the laying of the foundations can take place at a reduced foundation depth. The foundations can be laid using a crane, and can be adapted to the requirements of the project. The invention also relates to a method and means for the production of elements from which the foundations can be constructed.

U.S. Pat. No. 5,544,453 discloses a building construction in which a floor story of the building rests on a foundation which, in turn, lies on the ground. An insulated and separate service space is disposed beneath the floor story of the living accommodation, with room for accommodating heating, ventilation, and water supply systems as well as electrical systems. The insulated service space is formed mainly by the floor story of the building, a ground insulating layer, and a surrounding foundation wall. A gap is provided between the insulated service space and the first story with the gap extending along the inside of each foundation wall. A heating source is provided within the service space and exhausts heated air directly into the service space with the heated air flowing upwardly through the gap into the first story area.

U.S. Pat. No. 5,615,525 discloses a rigid, thermoplastic foam board useful in below-grade residential and commercial insulating and drainage applications. The board defines a plurality of oriented channels extending therein along the board. The channel extends into the board through a relatively narrow first opening at the face into a relatively wide first zone. The channel then further extends into the board from the first zone through a relatively narrow second opening into a second zone. The board provides superior water drainage, and protects a below-grade building wall from excessive moisture. Further disclosed is a method for using the foam board in below-grade applications.

U.S. Pat. No. 5,617,693 discloses a truss which is premanufactured and shipped to a job site for the construction of supper-insulated buildings walls has a two-by-four stud which is joined to a two-by-two stud positioned in spaced parallel relation to the first stud to form a twelve-inch-wide insulation cavity. The two-by-two stud is spaced from the two-by-four stud by spacers and is rigidly supported by diagonal cross braces. The braces and spacers are joined to the two-by-four stud by truss plates. A foundation is especially designed to accommodate the wall truss members. The truss has a sill extension 8½ inches wide formed of two-by-twos. The extension extends downwardly from the truss structure to provide an insulation face across the front of a step in the foundation. The wall trusses may be manufactured with the same equipment as utilized in the construction of floor and rafter trusses formed of dimensional two-by-fours. The ability to shop-fabricate the wall trusses using truss plates means that engineered truss members for each job can be supplied which minimize utilized material while, at the same time, saving considerable labor over on-site construction.

U.S. Pat. No. 5,704,172 discloses a rigid polymer foam board suitable for use in a foundation insulation system. The foam board has a face defining a plurality of grooves therein which traverse in a crossing, diagonal configuration. The groove configuration facilitates the application of insecticides/termiticides in foundation insulation systems employing rigid foam boards on the exterior of the foundation.

U.S. Pat. No. 5,740,636 discloses a weather block and vent member across the space between the ends of joists resting on a plate having between them an insulation blanket having a vapor barrier adjacent a ceiling on the bottom of the joists. The member blocks the flow of air towards the end of the vapor barrier and the ceiling and sometimes down past the plate in a wall inside covering and down pass the inside covering and the vapor barrier on the blanket insulation between the wall studs, and redirects it upwards along the rafters. It also blocks the flow of air across the plate, to eliminate the Bernoulli Effect thereat which was operative to suck the out the air between the wall-stud insulation vapor barrier and the wall interior covering. The weather block and vent is field adapted to the parameters of the building and is factory scored for easy field adaptation and so that it can be shipped flat for transportation economies.

U.S. Pat. No. 5,791,107 discloses a building, particularly in the context of a nuclear installation. The building is formed with an outer shell and an inner shell which form an intermediate space therebetween. A sealing element is disposed in the intermediate space. The sealing element is gas tight, it envelopes the inner shell, and it is largely freely movable perpendicularly to the surfaces of the shells defining the intermediate space. Pressure fluctuations, particularly pressure waves, originating on the inside of the building are received and equalized by the sealing element, while the gas-tightness of the sealing element is largely assured.

U.S. Pat. No. 5,806,252 discloses a waterproofing system and method for hydraulic structures which includes rigid sheets of synthetic material connected with flexible hinges made of sheets of synthetic material. Mechanical anchoring holds the rigid sheets in place.

U.S. Pat. No. 5,979,131 discloses an exterior insulation and finish system is produced for exterior construction having a primary weather proofing layer formed by a finish coat and a secondary seal is provided intermediate of the various layers of exterior insulation between a sheathing substrate and insulation board. The secondary seal layer also serves to adhesively secure the insulation board to the sheathing substrate.

U.S. Pat. No. 6,076,313 discloses a method and apparatus for providing a controlled environment for storing, producing, growing and/or processing at least one item. The method includes the steps of introducing an item into an enclosed storage space separated from an interior of a first thermal mass layer by a vessel formed of a heat conductive material. The exterior of the first thermal mass layer is then thermally isolated and the temperature of the first thermal mass is regulated to control the temperature in the enclosed storage space.

U.S. Pat. No. 6,122,887 discloses a geomembrane made from a custom blend of polyethylene copolymers, for protecting waterproofing courses from impact and pressure damage of debris resting against the waterproof course. A slip sheet configuration reduces surfaces stress due to earth movement and subsurface cracking thereby maintaining the protective course intact without any effect on the waterproofing layers. The geomembrane is available as lightweight rolls which can be easily be handled by one man. The film is installed horizontally in continuous sheets with few adhesive joints. Installation begins by applying a thick brush coat of the selected waterproofing membrane material (usually a rubber coat but may be any waterproofing material). The film is unrolled along the wall, held up into position and secured using plastic self-sealing plugs and/or plastic termination bars. Concrete nails are used to attach the self-sealing plugs or termination bar to the wall. If termination bar is selected the film is extended up beyond the bar approximately 8″ and folded down over the termination bar after attachment. Staples into the termination bar can be used to hold the film down creating a nicely detailed upper edge.

U.S. Pat. No. 6,360,496 discloses a circular building structure which comprises a plurality of columnar structures, each of which extends from a point below ground level to a desired height above ground level and wall structures positioned between the columnar structures and forming a substantially circular exterior wall with the columnar structures. The wall structures and the columnar structures enclose a substantially circular inner space. The building structure further includes a central hub positioned above the inner space. A plurality of trusses for supporting a roof are provided. Each of the trusses is joined to a respective one of the columnar structures and to the central hub. The inner space is divided into a parametric space and an interior space by an interior wall which is concentric with the exterior wall. The parametric space, in a preferred construction, is divided by walls into at least one passageway and a number of rooms. The interior space, in a preferred construction, is left as an undivided space which serves as a common area for eating, cooking, and other activities.

U.S. Pat. No. 6,477,811 discloses a method of construction of a damp-proof basement includes disposing a water-permeable palette layer on a bottom surface of the interior of the basement and spaced from an outer wall of the basement, disposing a water-impermeable vent layer over the palette layer, disposing a reinforced-concrete slab on the vent layer and spaced from the outer wall, and disposing an inner wall at a periphery of the concrete slab and spaced from the outer wall. A damp-proof basement construction includes a water-permeable palette layer, disposed on a bottom surface of the interior of the basement, spaced from an outer wall of the basement. A water-impermeable vent layer is disposed over the palette layer. A reinforced-concrete slab is disposed on the vent layer, spaced from the outer wall. An inner wall is disposed at a periphery of the concrete slab, spaced from the outer wall.

U.S. Pat. No. 6,568,136 discloses a method for building a floor in a structure, such as a house, designed to utilize the heat stored in the earth. The method includes the steps of building a continuous footing made of concrete on a location that corresponds to the location of an outer circumferential groundsill that is planned to be built around the outer circumference of a structure being built, providing a stone layer inside the continuous footing by placing stones to cover all of the area on the planned floor location, placing the outer circumferential groundsill on the continuous footing, placing an inside groundsill inside the outer circumferential groundsill and across the outer circumferential groundsill so that the inside groundsill can have its upper edge flush with the upper edge of the outer circumferential groundsill, placing concrete for forming an underfloor concrete layer along the respective upper edges of the outer circumferential groundsill and inside groundsill within the planned floor location and then flattening the upper surface of the resulting underfloor concrete layer, and placing flooring finish boards or slabs on the flattened surface of the underfloor concrete layer after the concrete becomes hardened. The floor that is finally obtained is capable of utilizing the heat stored in the earth and the like. The inside groundsill has anchor bolts previously installed that permit an easy mounting of columns or posts on the inside groundsill.

U.S. Pat. No. 7,313,891 discloses a system for finishing a concrete structure to increase the amount of useable space in a building. The finishing system comprises a plurality of connectable panels. An insulation layer is secured to the rear surface of the panels. The insulation layer has a generally flat front surface that is secured to the rear surface of the panels. The insulation layer also provides an uneven rear surface that is positioned adjacent to the existing basement foundation wall, and a pair of uneven side surfaces. The uneven rear and side surfaces of the insulation layer provide a plurality of grooves or dimples that allow moisture and air to move freely between the wall structure and the insulation layer. The panels and insulation layer are mounted to the existing wall structure by mounting brackets.

U.S. Pat. No. 7,407,004 discloses a structure utilizing geothermal energy capable of effectively utilizing a thermal energy in an underground constant temperature layer while using a supplementary heater and an air conditioner and natural energies such as solar heat or solar light, wind power, and water power in order to prevent limited fossil energies such as petroleum, gases, and coal from being exhausted, wherein an insulating wall (A) formed of a plurality of insulation panels (1) connected to each other and extending from a ground surface (4) to the underground constant temperature layer (21) is buried in the ground while surrounding a building (22) adhesively to the ground exposed portion and the underground buried portion of a foundation (5).

U.S. Pat. No. 7,735,271 discloses a system for forming an insulating vapor barrier in a building is especially suited for forming an insulating vapor barrier in a crawl space beneath a building. The system includes a series of separate vapor barrier panels that can be attached around a wall. A ground level vapor barrier can be sealed to the insulating vapor barrier panels, which can be sealed to each other and along a top edge to the wall. The individual vapor barrier panels include an insulating foam member with a vapor resistant liner laminated thereto and extending beyond the edges of the insulating foam member to provide space for securing and sealing multiple vapor barrier panels to form a continuous insulating vapor barrier. Mechanical or hook and loop fasteners can be provided to secure the top edges of the vapor barrier liners to the wall and bottom edges to a ground liner.

U.S. Pat. No. 7,908,801 discloses a material and method for insulating and providing a drainage path for a foundation wall includes a non-woven thermoplastic board being for insulating and providing a drainage path for a foundation wall. The non-woven thermoplastic board has a thermal resistance of an R-value per inch thickness of at least 1. The non-woven thermoplastic board also has a vertical drainage ability per inch thickness of at least 135 Gallons/Hour/Lineal-Foot/inch at a pressure of 500 pounds per square foot (psf).

U.S. Pat. No. 7,966,780 discloses a wall structure for absorbing or transferring heat from or to the ground, the wall structure comprising a footing for the wall structure disposed in the ground below grade extending in the longitudinal direction of the wall structure, a vertical wall supported on and extending longitudinally in the direction of the footing, the vertical wall extending upwardly from the footing above grade to a predetermined height, and having upper, lower, interior, exterior and end surfaces, a sheath of insulation for enveloping the vertical wall's upper, end, interior and exterior surfaces and thermal conductors disposed in the wall structure to be in thermal communication with one another, at least some of the conductors extending outwardly from the footing into the ground, the thermal conductors facilitating heat transfer between the ground and the vertical wall.

U.S. Pat. No. 8,011,144 discloses a slab edge forming and insulating system including edge members and support braces. The edge members include an elongated shell having an upright portion with an insulated inside surface, an upper portion and a lower portion. Each of the upper and lower portions have formed edges. Open cross-sectioned support braces having upper and lower formed edges for engaging the formed edges of the elongated shell are fixed to a footing and connected to the edge members. The edge members form and insulate the edges of the poured concrete of the slab while the open cross-sectioned support braces receive the poured concrete of the slab and thus anchor the edge members to the edge of the slab.

U.S. Pat. No. 8,215,083 discloses a previously formed unitary building exterior envelope product, comprising: a mineral fiber insulation board including a binder having a hydrophobic agent and is resistant to liquid water-penetration and has first and second major surfaces, an exterior facing material, which resists air infiltration and liquid water penetration, laminated to the first major surface, the exterior facing material being permeable to water vapor, and a continuous interior facing laminated to the second major surface, so that the second major surface is resistant to liquid water-penetration and is permeable to water vapor. The section of product is mounted to an exterior side of a plurality of framing members of an exterior wall of a building, so that the interior facing faces the framing members. An exterior layer is mounted to the framing members using a connection device that passes through the section of product, with the facing material facing the exterior layer.

Thus, the prior art does not provide an inexpensive, robust, simple, fully effective thermal barrier that can be attached to a slab foundation for residential or commercial buildings to prevent heat loss from the building through the slab.

### SUMMARY

The present invention addresses the unmet need of highly functional slab foundation insulation.

In one exemplary embodiment, the present invention comprises a prefabricated slab insulation device or installation adjacent the slab foundation of a building wherein the slab insulation device comprises: a substrate; a first attachment mechanism disposed at the top of the substrate for attaching the insulation apparatus to a building; a sheathing attached to the substrate; a reflective layer disposed between the sheathing and the substrate; and a second attachment mechanism for attaching the apparatus to the building, where the second attachment mechanism is disposed adjacent to one side of the sheathing and against the substrate.

Exemplary embodiments of the present invention may further comprise a vinyl substrate, foam sheathing, flexible polyethylene foam gasketing strip and/or an aluminum reflective layer. Exemplary embodiments of the present invention may also comprise a plywood nailing strip for attaching the insulation apparatus to a residential or commercial building slab.

An advantage of the present invention is that once installed the slab insulation device provides an R-value of at least about 5 inch of apparatus thickness. Another advantage of the present invention is that when installed it provides a U-value of at most about 0.20 inch of apparatus thickness. An additional advantage of the present invention is that when installed it provides a reduction in heat loss through the slab of at least about 20% and as much as over 60%.

In a second exemplary embodiment, the present invention comprises a prefabricated slab insulation device comprising a slab foundation set on a footer, said thermal barrier comprising: a footer insulating member, said footer insulating member disposed horizontally adjacent to the top of a footer, said footer insulating member comprising a generally cuboid shape having: an elongated top side and an elongated bottom side, wherein said bottom side and said top side are parallel; a pair of generally parallel front and rear sides; and at least one vertically oriented void between said parallel top and bottom portion, said void suitable for a structural material to pass through; an internal insulating member, said internal insulating member disposed vertically against a vertical wall of the footer, said internal insulating member extending downward from said footer insulating member, said internal insulating member generally in physical contact with said footer insulating member; and an exterior insulating member, said exterior insulating member disposed at about the front side of the footer insulting member, such that: said exterior insulating member is adjacent to the exterior of a building; and such that the exterior insulating member extends vertically upward from said footer insulating member; and such that said exterior insulating member is generally parallel to said internal insulating member; and such that said exterior insulating member is generally in physical contact with said footer insulating member.

Advantageously, this second embodiment provides a continuous thermal barrier at the side of the slab and between the bottom of the slab and the footer for the foundation.

Again, an advantage of the present invention is that when installed it provides an R-value of at least about 5 inch of apparatus thickness between the slab and ambient conditions. A second advantage of the present invention is that when installed it provides a U-value of at most about 0.20 inch of apparatus thickness between the slab and ambient conditions. An additional advantage of the present invention is that when installed it provides a reduction in heat loss through the top or bottom perimeter of the slab.

These and other aspects, features, and advantages of the present invention will become more readily apparent from the attached drawings and the detailed description of the preferred embodiments, which follow.

### BRIEF DESCRIPTION OF THE DRAWINGS

The present invention will be understood more fully from the detailed description given hereinafter and from the accompanying drawings of exemplary embodiments of the present invention. However, the drawings and descriptions herein should not be taken to limit the invention; they are for explanation and understanding only.

FIG. 1 is a cross-sectional view of a typical monolithic building foundation slab with a prior art insulation system.

FIG. 2 is a cross-sectional view of a typical non-monolithic building foundation slab with a prior art insulation system.

FIG. 3 is a cross-sectional view of a slab insulation device according to a first embodiment of the present invention.

FIG. 4 is a cross-sectional view of non-monolithic building foundation slab with the slab insulation device of FIG. 3 attached to a building having a slab.

FIG. 5 is a side cross-sectional view of a building foundation slab with an attached slab insulation device according to a second embodiment of the present invention.

FIG. 6 is a top view of a footer insulating member according to a second embodiment of the present invention.

FIG. 7 is a perspective view of an installed footer insulating member according to a second embodiment of the present invention.

FIG. 8 is a top view of an embodiment of a footer insulating member according to a third embodiment of the present invention.

FIG. 9 is a top view of a wall section of a footer insulating member according to the embodiment of the present invention that is shown in FIG. 8.

FIG. 10 is a top view of a corner section of a footer insulating member according to the embodiment of the present invention that is shown in FIG. 8.

FIG. 11 is a side cross-sectional view of a footer insulating member according to the present invention.

FIG. 12 is a top cross-sectional view of a footer insulating member according to the present invention.

Like reference numerals refer to like parts throughout the several views of the drawings.

### DETAILED DESCRIPTION OF THE EMBODIMENTS

The present invention will be discussed hereinafter in detail in terms of the preferred embodiment according to the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscuring of the present invention.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations.

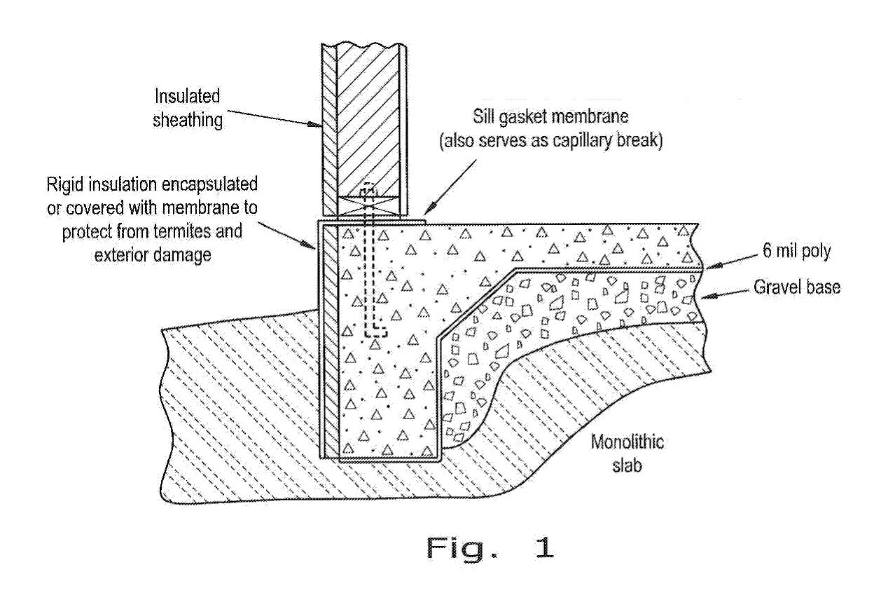

All of the implementations described below are exemplary implementations provided to enable persons skilled in the art to make or use the embodiments of the disclosure and are not intended to limit the scope of the disclosure, which is defined by the claims. In the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIG. 1, there is shown a typical monolithic “floating” slab for the foundation of a residential or commercial building with a prior art insulation system. As shown in FIG. 1, a typical, monolithic, floating slab foundation system comprises a concrete slab; a gravel layer; strength enhancing, and, preferably steel reinforcement members within the slab.

As shown in FIG. 1, this prior art system may further comprise a rigid insulating sheathing disposed against an exterior edge of the slab and a plastic or rubber gasket membrane disposed on the ground facing, exterior wall of the rigid sheathing. The membrane functions to protect the insulation from damage due to pest infestation or moisture.

Referring still to FIG. 1, an exterior wall of a residential or commercial building disposed on top of the slab foundation and the membrane is shown. The building wall may have exterior and interior insulating sheathing.

One problem with the prior art system shown in FIG. 1 is that a break exists between the above ground and below ground exterior insulation. Consequently, significant heat can escape the building through the slab and between the two insulation segments.

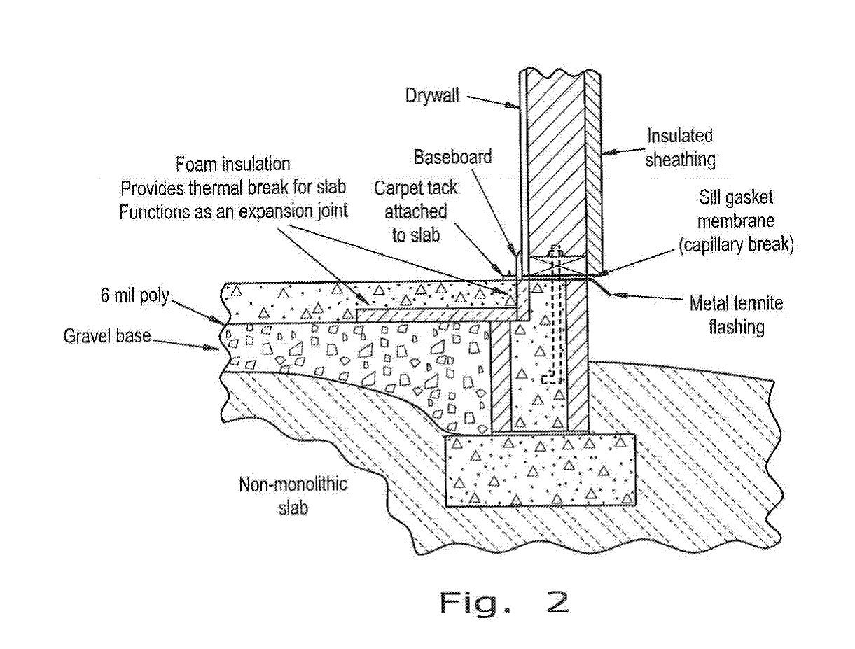

Referring now to FIG. 2, there is shown a typical non-monolithic “floating” slab for the foundation of a residential or commercial building with a prior art insulation system. As shown in FIG. 2, the slab is poured such that it comprises a generally horizontal top and a plurality of vertical walls disposed around the perimeter of the horizontal top. The walls are entrenched in the ground, preferably at a depth of about 3 feet. As further illustrated in FIG. 2, the vertical perimeter walls rest on a footer. The slab further includes a plurality of reinforcing members disposed vertically within the slab. The reinforcing members are oriented such that they cross from the perimeter walls of the slab into and through the horizontal top portion of the slab.

Referring again to FIG. 2, the horizontal top of the slab rests atop a layer of gravel. A polymer membrane is disposed atop the layer of gravel, and a horizontal layer of foam insulation is disposed between the polymer membrane and the bottom of the horizontal portion of the slab. The foam insulation provides a thermal break for the slab and functions as a mechanical expansion joint. The polymer membrane prevents moisture from damaging the horizontally disposed foam insulation layer.

Referring again to FIG. 2, there is shown a frame around the vertical walls of the slab. The frame itself has two vertical walls that sandwich the vertical perimeter walls of the slab as shown in FIG. 2. As further illustrated in FIG. 2, the exterior walls of a building rest on the slab foundation such that they are generally collinear with the perimeter walls of the slab. The walls of the building generally comprise an interior drywall layer and an exterior insulating sheathing layer. A polymer membrane is disposed between the bottom of the building exterior walls and the top of the horizontal portion of the slab.

Much like the prior art slab insulation system of FIG. 1, a problem with the prior art system shown in FIG. 2 is that a break exists between the above ground and below ground exterior insulation. Consequently, significant heat can escape the building through the slab and between the two insulation segments, as well as through the gap between the exterior wall of the building and the horizontal portion of the slab.

A second problem with the prior art system shown in FIG. 2, is that the interior flooring in such a system cannot be secured without breaking or coming loose in the corners such that certain desirable floorings, such as tile, cannot be used. Past methods such as bringing the interior foam to the top of the slab with a beveled edge on the top of the slab have caused deflection between the slab and footer area of slab, and separation between slab and footer area of slab due to lack of a monolithic pour with the foam being the barrier.

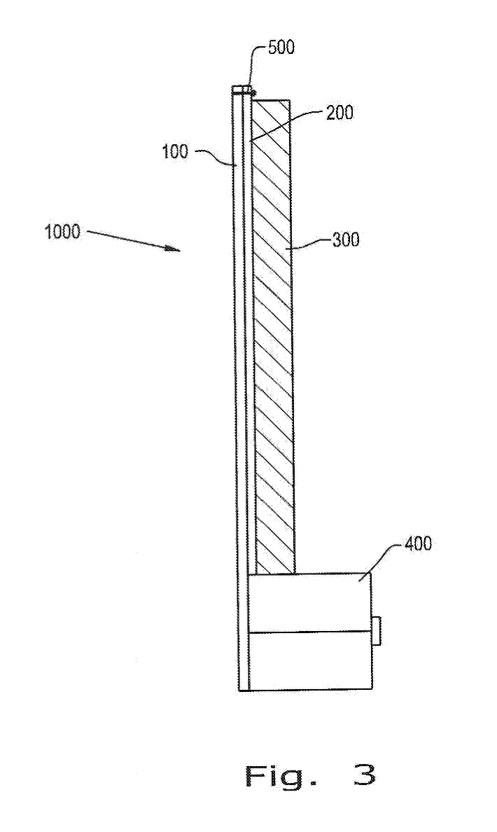

Referring now to FIG. 3, there is shown a cross-sectional view of a slab insulation device according to a first embodiment of the present invention. As shown in FIG. 3, device 1000 generally comprises a substrate 100, a reflective layer 200, and a sheathing layer 300.

Referring again to FIG. 3, substrate 100 is comprised of a durable, inexpensive, corrosion resistant material suitable for securely retaining the remaining elements of slab insulation device 1000. Preferably, substrate 100 is comprised of vinyl. However, those of skill in the art will appreciate that any durable, reasonably structurally sound material such as wood, composite, or polymer will suffice. A flexible polyethylene foam gasketing strip attached to the interior of the product as it attaches to the slab may also be included.

As further illustrated in FIG. 3, thermal barrier 1000 further comprises sheathing layer 300. Sheathing layer 300 preferably comprises and insulating material such as polyisocyanurate with a thickness within a range of from about 1 inches to about 2 inches. A thickness of 1 results in an R-value of 5-7. Thus, the thickness of insulating sheathing layer 300 can be increased or decreased to achieve a desired R-value.

Those of skill in the art will appreciate that a number of materials may be used for sheathing layer 300, including extruded foam, polyisocyanurate foam, expanded foam, and insulating foil bubble wrap material or similar material.

Referring again to FIG. 3, a reflective layer 200 is disposed between substrate 100 and sheathing layer 300. Reflective layer 200 comprises a material such as aluminum. As further illustrated in FIG. 3, reflective layer 200 may be attached to one side of sheathing layer 300.

Referring still to FIG. 3, in the preferred embodiment, the elements of slab insulation device 1000 are secured to one another such that they form a singular device. Although slab insulation device 1000 may be of any desired size and shape, it is preferable for it to have a rectangular shape with a length ranging from about 4 feet to about 8 feet.

As shown in FIG. 3, slab insulation device 1000 further comprises bottom nailing strip 400. Nailing strip 400 is disposed such that it attached to substrate 100 and abuts the bottom of insulating sheathing layer 300. Nailing strip 400, used so that slab insulation device 1000 may be nailed to the exterior of a residential or commercial building, comprises a wood or composite material, preferably plywood.

As further illustrated in FIG. 3, slab insulation device 1000 may further comprise top nailing strip 500. Nailing strip 500 preferably comprises a vertical extension of vinyl substrate 100. Although the preferred embodiment of slab insulation device 1000 is designed to be nailed to the exterior of a building, those of skill in the art of construction will appreciate that other securing methods or means are suitable for attaching slab insulation device 1000 to a building, such as tacks, screws, adhesives, tape, snap-fit, tab and groove, or a combination of these methods. Additionally, slab insulation device 1000 may comprise a final external protective polymer layer (not shown) opposite said substrate 100.

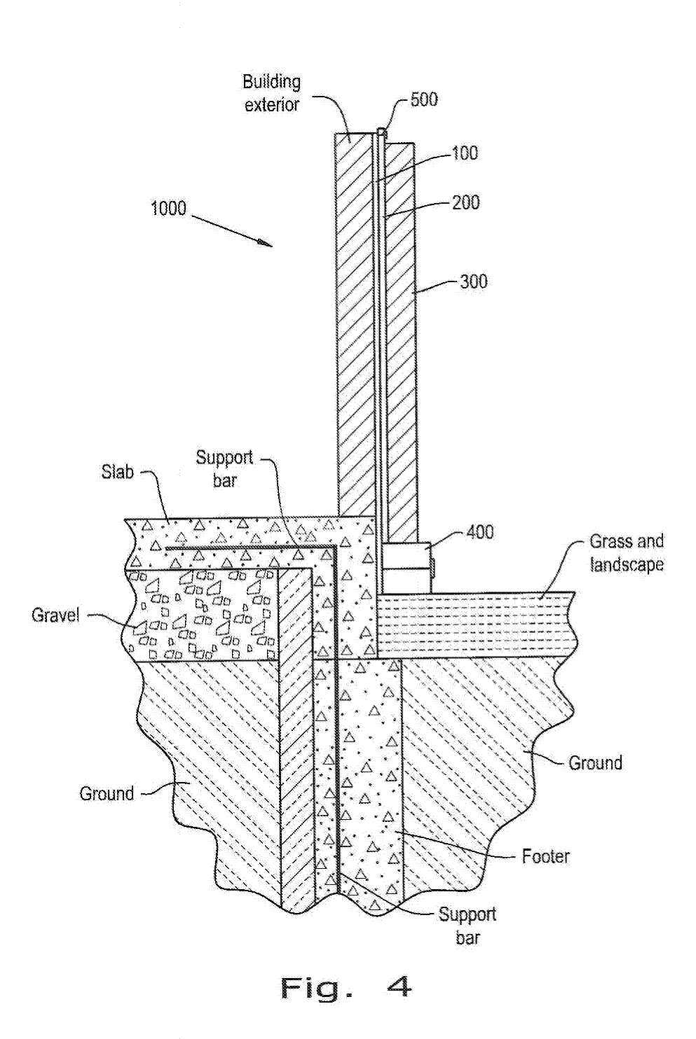

Referring now to FIG. 4, there is shown a cross-sectional view of slab insulation device 1000 attached to the exterior of a residential building having slab foundation. As shown in FIG. 4, slab insulation device 1000 is preferably nailed to the exterior of a building such that device 1000 extends vertically below the horizontal layer of the slab foundation of the building and below the uppermost portion of any insulation on the interior of the slab perimeter wall. Thus, heat loss through the slab foundation of the building is diminished.

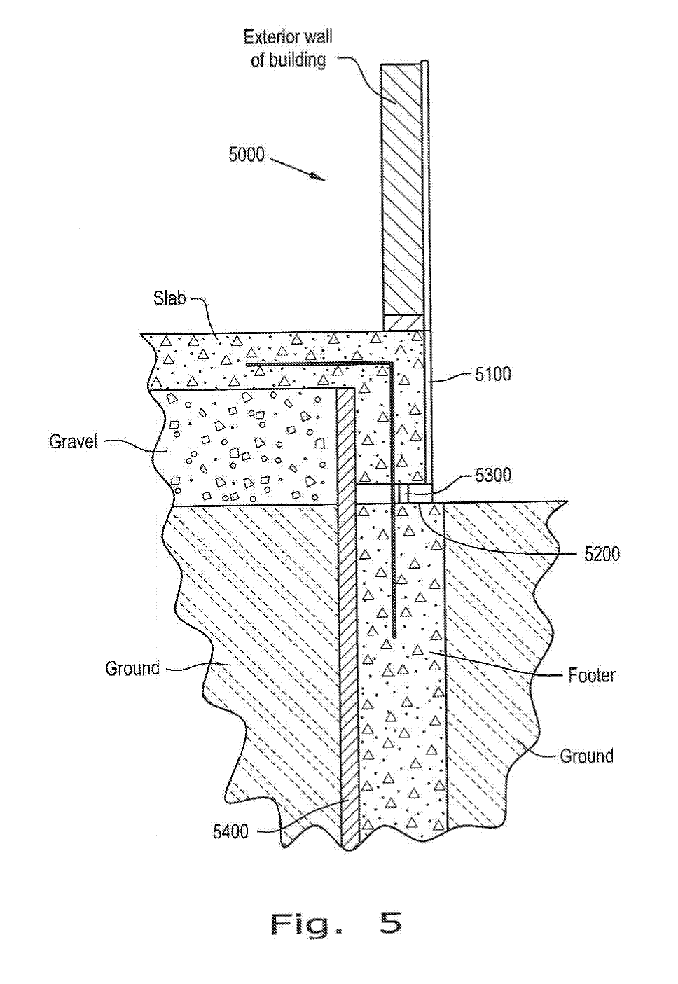

Referring now to FIG. 5, there is shown an alternative embodiment of the present invention. As shown in FIG. 5, slab insulation device 5000 provides continuous insulation around the exterior perimeter of the building's slab foundation and between the slab and the footer. This continuous insulation (with no thermal break) provides even greater prevention of heat loss through the slab foundation.

Referring still to FIG. 5, slab insulation device 5000 generally comprises an exterior insulating member 5100, a footer insulating member 5200, and an internal insulating member 5400. As shown in FIG. 5, each of the above described insulating members is generally in continuous contact with one another and the slab such that there is no air gap between the perimeter of the slab and ambient conditions or between the perimeter of the slab and the footer.

Referring again to FIG. 5, exterior insulating member 5100 of slab insulation device 5000 preferably comprises an insulating material such as expanded polystyrene, polyisocyanurate, or extruded polystyrene.
Polyisocyanurate (polyiso for short) foam has the highest R-value per inch (R-6.5 to R-6.8) of any rigid insulation. This type of rigid foam usually comes with a reflective foil facing on both sides, so it can also serve as a radiant barrier in some applications. Polyiso board is more expensive than other types of rigid foam. Extruded polystyrene (XPS) rigid foam is usually blue or pink in color, with a smooth plastic surface. XPS panels typically aren't faced with other material. The R-value is about 5 per in. This type of rigid foam won't absorb water like polyiso and is stronger and more durable than expanded polystyrene, so it's probably the most versatile type of rigid foam. XPS falls between polyiso and expanded polystyrene in price. Expanded polystyrene (EPS) is the least-expensive type of rigid foam and has the lowest R-value (around R-3.8 per in.). It's also more easily damaged than the other types of rigid foam.
   Dr. Energy Saver Home Services, Rigid Insulation Board: R-value Packed into a Rigid Foam Panel, available at http://www.drenergysaver.com/insulation-materials/rigid-insulation-board.html (last visited Dec. 27, 2012).

However, persons of ordinary skill in the arts of building construction or thermal insulation will appreciate that any convenient insulation material will suffice as long as it meets or can be adapted to meet the configuration of the present invention and any applicable construction regulations. Preferably, exterior insulating member 5100 is of semi-rigid construction.

As shown in FIG. 5, exterior insulating member 5100 is disposed vertically against and fixedly attached to the exterior of the building. In the preferred embodiment, exterior insulating member 5100 extends from just above the upper surface of the slab to contact horizontally disposed footer insulating member 5200. As shown in FIG. 5, the top side of footer insulating member 52 is in abutting, physical contact with exterior insulating member 5100. If contact is not achieved between exterior insulating member 5100 and footer insulating member 5200, any gaps can be filled using known non-rigid insulating materials.

Referring still to FIG. 5, slab insulation device 5000 further comprises footer insulating member 5200. Footer insulating member 5200 should be of semi-rigid construction. Footer insulating member 5200 is also preferably comprised of an insulating material such as expanded polystyrene, polyisocyanurate, or extruded polystyrene. However, persons of ordinary skill in the arts of building construction or thermal insulation will again appreciate that any convenient insulation material will suffice as long as it meets or can be adapted to meet the configuration of the present invention and any applicable construction regulations.

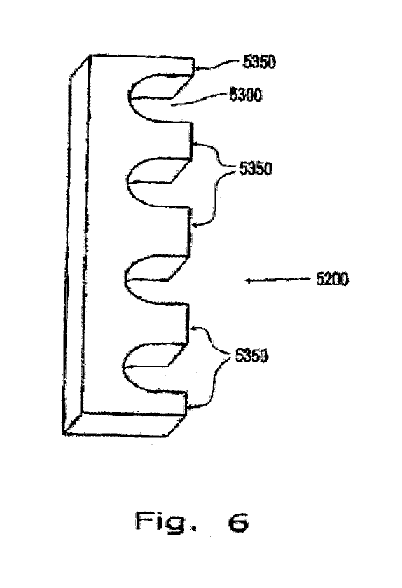

Turning to FIG. 6, there is shown a top view of elongate footer insulating member 5200, which is generally cuboid in shape. Footer insulating member 5200 is the second portion of continuous thermal barrier 5000. Footer insulating member 5200 is disposed vertically atop the footer and is disposed between the footer and slab. As building insulation materials are not weight bearing, footer insulating member 5200 further comprises at least one void 5300 extending therethrough between its top and bottom sides. During pouring of the slab, concrete is received into and flows through the at least one void 5300 to serve, once that concrete has cured, as a structural support column for the slab and building upon the footer. In the preferred embodiment, voids 5300 comprise a shape selected from the group consisting of a semi-cylinder as shown, a cylinder, a cuboid, and a polyhedron, and the linear frequency of voids 5300 is about 1 void 5300 per 24 inches. Moreover, each void 5300 preferably has a volume of from about 3 cubic inches to 11 cubic inches.

As shown in FIG. 6, each void 5300 defines a generally semi-cylindrical shape. However, other geometric void shapes may be used such that a void 5300 defines a polyhedron, a cuboid, a cylinder, or any desired shape. Moreover, while a portion of each void 5300 is shown open to footer insulating member interior edge 5350, it will be understood by those of ordinarily skill in the art of building construction that voids 5300 could be enclosed.

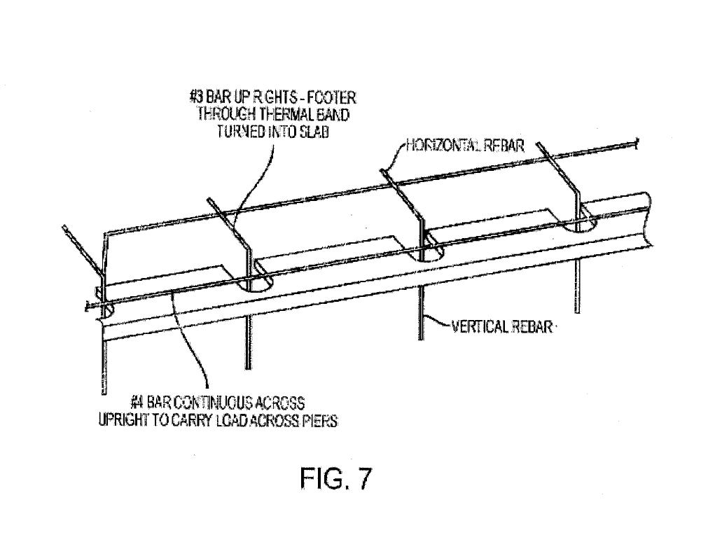

Any desired number, shape, and size of void 5300 may be used in the present invention. The determination of those parameters is based on the material properties of the slab and footer and the desired weight that the slab is intended to hold. For example, medium grade concrete holds about 4,000 pounds per square inch. As illustrated in FIG. 7, footer insulating member 5200 works in conjunction with vertically and horizontally installed rebar through adjacent concrete footer and slab.

A prototype of the above described embodiment of the president invention was produced for testing by Home Innovation Research Labs (“HIRL”), an independent laboratory located at 400 Prince George's Blvd. Upper Marlboro, Md. 20774, to determine the structural safety of using the present invention as described herein. In general, the prototypes tested by HIRL were as described herein and shown in FIGS. 5, 6, and 7 of the present application.

The voids or cutouts in the footer insulation member of the slab insulation device provide a path for 3-inch diameter cylindrical support piers between the turndown slab and the footer when the concrete slab is poured. The support piers are nominally spaced at 2 feet on center.

For all test specimens the follow process was used to cast the specimens. The footer section was cast on May 30, 2013 and the slab section was cast the following day to simulate typical production scheduling. No adhesion enhancement was done when casting the cold joint between the footer and the slab portion of the test specimen. Commercial ready-mix concrete specified at 3500 psi (slump<5″) was used for both the footer and slab portions. A pencil vibrator was used to assist in filing out the forms. Concrete cylinders were cast and tested by a third-party testing firm. All the test specimens were allowed to cure for 28 days before testing began.

The support piers need to support not only the dead load and live load of the building, they also need to resist compression load that may result from shear loading on the walls. The worst-case combination of loads is likely to be in a corner. The testing was designed to simulate a worst-case corner construction.

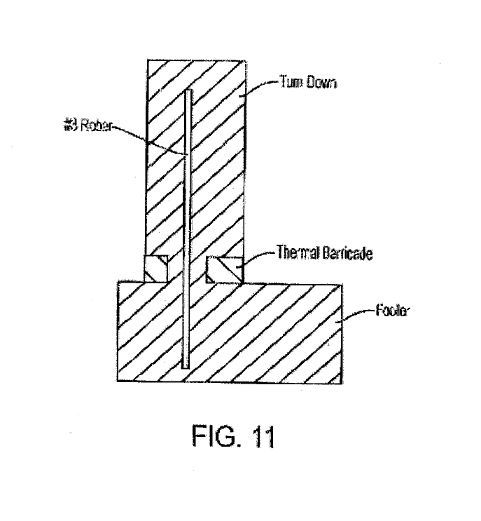

Three specimens were constructed. Each specimen had a 3″ diameter circular support pier supporting a 6″×6″ section of a slab turndown. The turndown was 11.25″ thick. A #3 rebar was placed vertically in the center of the support pier and contained a 90-degree bend as if it were entering the slab. See, for example, FIG. 11.

Each test specimen was loaded into Home Innovation Labs's large universal testing machine (“UTM”). The specimen was loaded through a 3.5″×3.5″ square steel plate located where the bottom plate in typical construction would be located. This location placed the load slightly eccentric to the support pier. The compression load was applied at a rate of 0.0525 inches/minute. This rate was determined by testing concrete cylinders per ASTM C39 and using the same rate as appropriate for that test method. The specimen was loaded until failure. In the test, the failure of all three specimens was due to failure of the slab portion of the specimen due to the slightly eccentric loading. The table below shows the results of the compression testing:

| Specimen # | Ultimate Load (pounds) |
|---|---|
| 1 | 53565 |
| 2 | 56312 |
| 3 | 51571 |
| Mean | 53816 |
| Standard Deviation | 2380 |

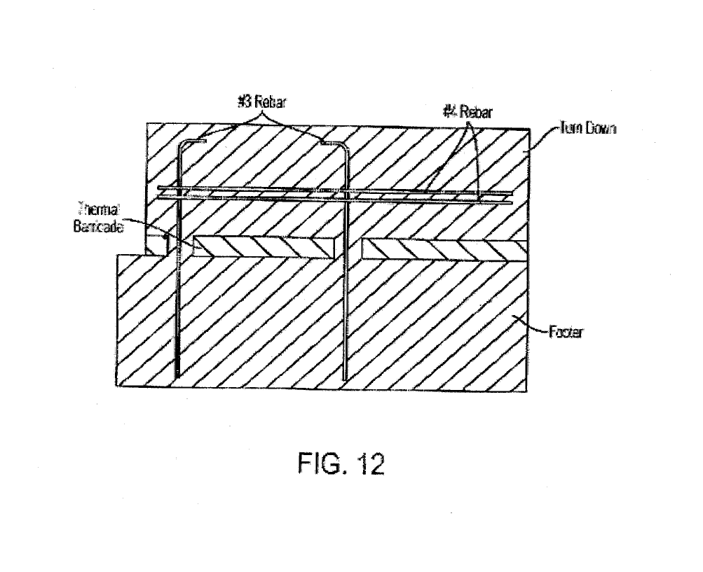

For the three shear test specimens that were prepared, a 4-foot-long footer section 10″ wide by 16″ deep was formed and cast with one #3 rebar protruding upward where the center of each support pier would be cast as part of the slab. See, for example, FIG. 12.

After curing for one day, the thermal barricade foam insulation was placed on top of the footer section 2.5″ from the end of the footer. The test specimen contained two support piers spaced 2 feet apart with the first pier centered 6″ from the end of the footer. A turned down slab section that began 4″ from the end of the footer measuring 6″ wide by 44″ long by 11.25″ deep was cast on top of the thermal barricade. Two #4 rebars were placed horizontally through the turned down section and zip tied to the vertical #3 rebars protruding from the footer.

A piece of 2×6 nominal lumber was glued to each side of the footer and were used as lifting points to transfer the specimen in and out of the test setup. The lumber was not intended to be part of the test nor was it part of the thermal barricade system. Each test specimen was mounted in Home Innovation's shear wall test apparatus. A typical ASTM E72 test set up was used. Per ASTM E72 a hold down structure was used to limit uplift as the shear load was applied.

The shear load was applied via a 5″×6″ steel plate placed on the end of the slab section. This set up was designed to cause failure at the support piers. The load was applied at a rate of 0.1 inches/minute. Each specimen was instrumented to record slip and uplift. In order to better observe the failure mode as it occurred, the foam thermal barricade was removed from the third specimen prior to testing.

The shear testing resulted in an initial failure of the support pier followed by bending and yielding of the rebar as the displacement continued. The table below summarizes the results of the shear testing at the initial failure of the support pier.

| | | Displacement at |
|---|---|---|
| | Load at initial failure | initial failure |
| Specimen # | (pounds) | (inches) |
| 1 | 4100 | 0 |
| | (see discussion) | |
| 2 | 8832 | 0 |
| 3 | 10467 | 0 |
| Mean | 7800 | 0 |
| Standard Deviation | 3307 | 0 |

Referring again to FIG. 5, there is shown an internal insulating member 5400. Internal insulating member 5400 generally comprises a rectangular or cuboid shape of any desired width, length, and height for use during home construction. Internal insulating member 5400 is also preferably comprised of an insulating material such as expanded polystyrene, polyisocyanurate, or extruded polystyrene. However, persons of ordinary skill in the arts of building construction or thermal insulation will again appreciate that any convenient insulation material will suffice as long as it meets or can be adapted to meet the configuration of the present invention and any applicable construction regulations.

As shown in FIG. 5, internal insulating member 5400 is disposed between the “house side” of the footer and the ground. Internal insulating member 5400 extends vertically such that it contacts the interior edge(s) 5350 of footer insulating member 5200. Internal insulating member 5400 preferably further extends vertically to at or near the bottom horizontal surface of the slab.

Again, as shown in FIG. 5, internal insulating member 5400 should contact the interior edge(s) 5350 of footer insulating member 5200 of thermal barrier 5000. If, during construction, these members do not fully contact, insulating foam may be used to help achieve a contiguous barrier between the perimeter of the slab and ambient conditions.

Of course, those of skill in the art will appreciate that each of the components of slab insulating device 5000 may be used independently if desired.

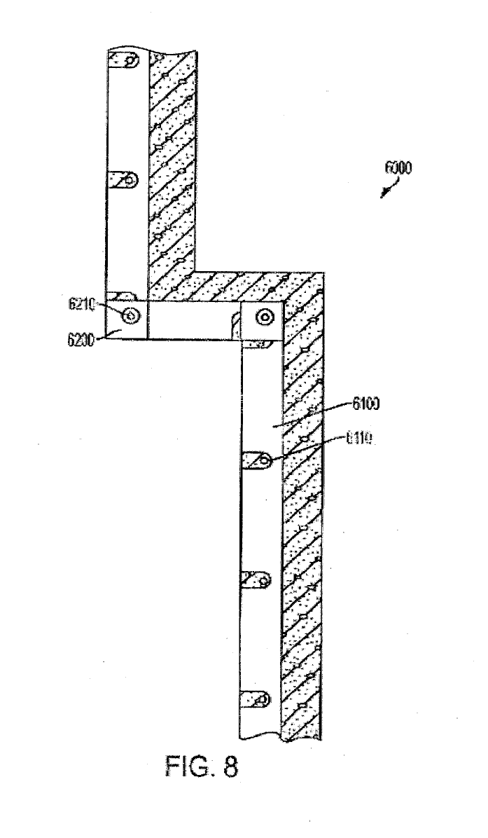

Referring now to FIG. 8, there is shown a top view of an embodiment of a footer insulating member 6000 according to a third embodiment of the present invention. As illustrated in FIG. 8, footer insulating member 6000 comprises at least one long wall insulating section 6100. Footer insulating member 6000 may further comprise at least one corner insulating sections 6200.

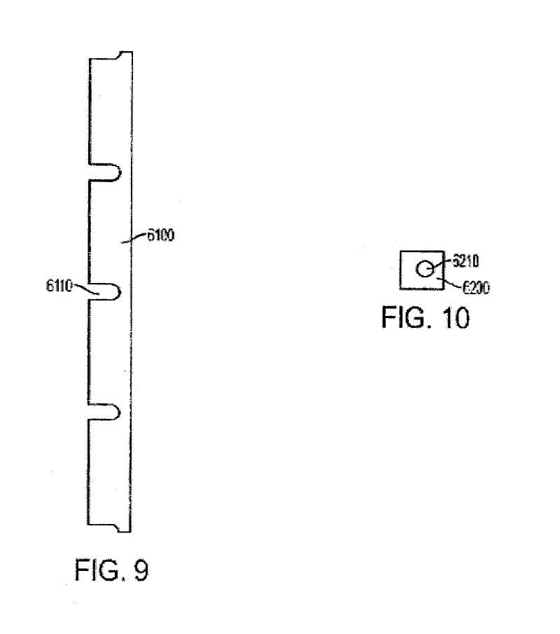

Referring now to FIG. 9, there is shown a top view of wall section 6100 of footer insulation member 6000 according to the embodiment of the present invention that is shown in FIG. 8. As illustrated in FIG. 9, wall section 6100 of footer insulating member 6000 comprises a plurality of cut-outs/voids 6110 through which concrete can flow when a slab is poured over footer insulating member 6000 as described in more detail above.

Referring now to FIG. 10, there is shown a top view of a corner section 6200 of footer insulation member 6000 according to the embodiment of the present invention that is shown in FIG. 8. As illustrated in FIG. 10, corner section 6200 of footer insulating member 6000 comprises a generally cuboid shape having a central bore 6210 through which concrete can flow when a slab is poured over footer insulating member 6000 as described in more detail above.

The above-described embodiments are merely exemplary illustrations set forth for a clear understanding of the principles of the invention. Many variations, combinations, modifications, or equivalents may be substituted for elements thereof without departing from the scope of the invention. It should be understood, therefore, that the above description is of an exemplary embodiment of the invention and included for illustrative purposes only. The description of the exemplary embodiment is not meant to be limiting of the invention. A person of ordinary skill in the field of the invention or the relevant technical art will understand that variations of the invention are included within the scope of the claims.

1. A device for insulating the slab foundation of a building, said device comprising: a generally horizontal insulating section disposed between the slab foundation and a footer of a building, said horizontally disposed insulating section comprising a generally elongated cuboid shape having at least one cutout through which a concrete column is disposed; said prefabricated device further comprising a generally vertical insulating section disposed adjacent to said horizontal insulating section and attached to said building.

2. The device of claim 1, wherein the device is prefabricated and comprises a material selected from the group consisting of extruded foam, polyisocyanurate foam, expanded foam, insulated foil bubble wrap, and blown insulation.

3. The device of claim 1, wherein the material comprises an additive selected from the group consisting of an insecticide, an herbicide, a fungicide, and a water repellant.

4. The device of claim 1, wherein the vertical insulating section further comprises a semi rigid external sheath.

5. The device of claim 1, further comprising a vertical metal bar disposed through at least one column, where the bar comprises a material selected from the group consisting of steel, iron, and metal alloy.

6. The device of claim 1, further comprising a horizontal metal bar disposed across the device through and perpendicular to the at least one column, where the bar comprises a material selected from the group consisting of steel, iron, and metal alloy.

7. The device of claim 1, wherein each concrete column is capable of bearing a vertical load of at least about 20,000 pounds.

8. The device of claim 1, wherein the device has an R-value of at least about 5 per inch of material thickness.

9. A device for insulating the slab foundation of a building, said device horizontally disposed between the slab foundation and footer of a building, said device comprising a generally elongated cuboid shape having at least one cutout through which a concrete column is disposed.

10. The device of claim 9, wherein the device is prefabricated and comprises a material selected from the group consisting of extruded foam, polyisocyanurate foam, expanded foam, insulated foil bubble wrap, and blown insulation.

11. The device of claim 9, wherein the material comprises an additive selected from the group consisting of an insecticide, an herbicide, a fungicide, and water repellant.

12. The device of claim 9, further comprising a vertical metal bar disposed through at least one column, where the bar comprises a material selected from the group consisting of steel, iron, and metal alloy.

13. The device of claim 9, further comprising a horizontal metal bar disposed across the device through and perpendicular to the at least one column, where the bar comprises a material selected from the group consisting of steel, iron, and metal alloy.

14. The device of claim 9, wherein each concrete column is capable of bearing a vertical load of at least about 20,000 pounds.

15. The device of claim 9, wherein the device has an R-value of at least about 5 per inch of material thickness.

16. A method of insulating the slab foundation of a building, said method comprising the steps of: providing a footer for a building; providing a horizontally disposed insulating device, said device comprising a generally elongated cuboid shape having at least one vertically disposed cutout therethrough; pouring a concrete slab foundation for the building such that structurally supportive columns for the slab are created through the cutouts.

17. The device of claim 16, wherein the device is prefabricated and comprises a material having an R-value of at least about 5 per inch of thickness and wherein the material is selected from the group consisting of extruded foam, polyisocyanurate foam, expanded foam, insulated foil bubble wrap, and blown insulation.

18. The device of claim 16, wherein the material comprises an additive selected from the group consisting of an insecticide, an herbicide, a fungicide, and water repellant.

19. The device of claim 16, further comprising: a vertical metal bar disposed through at least one column; and a horizontal metal bar disposed across the device through and perpendicular to the at least one column, where the bars comprise a material selected from the group consisting of steel, iron, and metal alloy.

20. The device of claim 16, wherein each concrete column is capable of bearing a vertical load of at least about 20,000 pounds.
